(19) United States
(12) Patent Application Publication
(10) Pub. No.: US 2010/0207777 A1
(43) Pub. Date: Aug. 19, 2010

(54) COMBINATION FIRE ALARM NOTIFICATION/EMERGENCY LIGHTING APPLIANCE

(75) Inventor: James F. Woodford, Templeton, MA (US)

Correspondence Address: Tyco International LTD, Ip Legal Department, One Town Center Road, BOCA RATON, FL, 33486, US

(73) Assignee: SIMPLEXGRINNELL LP, Westminster, MA (US)

(21) Appl. No.: 12/706,788

(22) Filed: Feb. 17, 2010

Related U.S. Application Data
(60) Provisional application No. 61/153,801, filed on Feb. 19, 2009.

(51) Int. Cl. G09F 9/33

(52) U.S. Cl. 340/815.45

(57) ABSTRACT

A notification appliance includes one or more high-brightness light-emitting diodes (LEDs) and a control module configured to receive commands from an external source, and in response to a first command, flash the at least one LED, and in response to a second command, turn the at least one LED on in a steady state.

### CROSS REFERENCE TO RELATED APPLICATIONS

The application relates to and claims priority from Provisional Patent Application Ser. No. 61/153,801, titled “COMBINATION FIRE ALARM NOTIFICATION/EMERGENCY LIGHTING APPLIANCE”, filed Feb. 19, 2009, the complete subject matter of which is expressly hereby incorporated herein in its entirety.

### BACKGROUND OF THE INVENTION

This invention relates generally to fire systems, and more particularly, notification appliances.

### BRIEF DESCRIPTION OF THE INVENTION

In one embodiment, a notification appliance comprises an alarm indicator and a control module which is configured to perform a notification function and comprises one or more high-power, high-brightness light-emitting diodes (LEDs), and a control module that receives commands from an external source. In response to a first received command, the control module flashes one or more of the LEDs, which may be selectable depending for example on the required brightness. In response to a different command, the control module may cause one or more of the LEDs to turn on in a steady state mode so as to provide emergency lighting, for example when main power has been lost.

Where the notification appliance has plural LEDs, not all of the LEDs need be used for both strobe and background lighting functions. For example, in one case, all of the LEDs may be used to provide a bright emergency strobe, but only a subset of the LEDs may turn on steady when emergency background lighting is required. This will save power by not drawing on the backup power supply as heavily as if all LEDs were on.

The notification appliance's LED(s) may also be capable of emitting at least two distinct colors. For instance, each LED may itself be able to emit different colors, or separately colored LEDs may be employed. The control module may be configured to select a color to be emitted by the notification appliance, depending on the command received and/or the mode (i.e., strobe v. steady on).

A notification system according to an embodiment of the present invention includes a system controller and plural notification appliances, wherein at least some of the notification appliances have one or more high-brightness light-emitting diodes (LEDs) and a control module configured to receive commands from the system controller; wherein in response to a first command, the control module flashes all or a first subset of the LEDs, and in response to a second command, the control module turns on all or a second subset of the LEDs in a steady state. The system controller may also sequence multiple notification appliances such that they provide a visual indication of a pathway to an egress. In certain embodiments, the system controller may also select one of plural colors to be emitted by the sequenced notification appliances to identify a particular situation/condition.

### BRIEF DESCRIPTION OF THE DRAWINGS

FIG. 1 illustrates an alarm system in accordance with an embodiment of the present invention.

The foregoing summary, as well as the following detailed description of certain embodiments of the present invention, will be better understood when read in conjunction with the appended figures. It should be understood that the present invention is not limited to the arrangements and instrumentality shown in the attached figures. The figures illustrate diagrams of the functional blocks of various embodiments. The functional blocks are not necessarily indicative of the division between hardware circuitry. Thus, for example, one or more of the functional blocks (e.g., processors or memories) may be implemented in a single piece of hardware (e.g., a general purpose signal processor or a block or random access memory, hard disk, or the like). Similarly, the programs may be stand alone programs, may be incorporated as subroutines in an operating system, may be functions in an installed imaging software package, and the like.

### DETAILED DESCRIPTION OF THE INVENTION

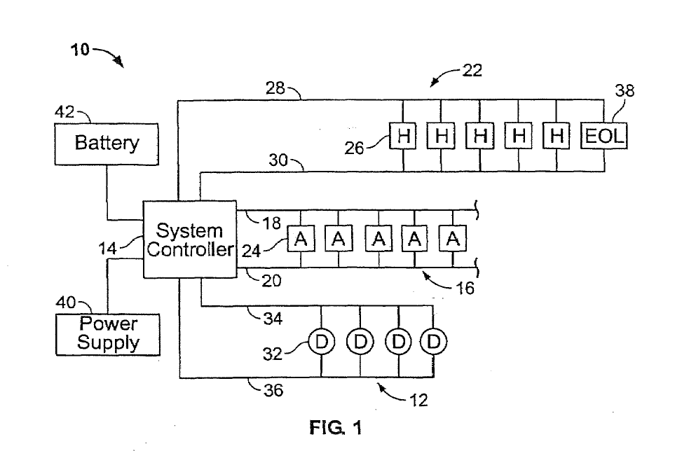

FIG. 1 illustrates an alarm system 10 in accordance with an embodiment of the present invention. The system 10 includes one or more detector networks 12 having individual alarm condition detectors 32 which are monitored by a system controller 14. The detectors 32 may detect fire, smoke, temperature, chemical compositions, or other conditions. The alarm condition detectors 32 are coupled across a pair of power lines 34 and 36. When an alarm condition is sensed, the system controller 14 signals the alarm to the appropriate notification devices through one or more networks 16 of addressable alarm notification appliances 24 and/or one or more networks 22 of hardwired (e.g. non-addressable) alarm notification appliances 26. The networks 16 and 22 are also referred to as a notification appliance circuit (NAC).

The system controller 14 is connected to a power supply 40 which provides one or more levels of power to the system 10. One or more batteries 42 provide a back-up power source for a predetermined period of time in the event of a failure of the power supply 40 or other incoming power. Other functions of the system controller 14 includes showing the status of the system 10, control resetting a part or all of the system 10, silencing signals, turning off strobe lights, and the like.

The addressable notification appliances 24 are coupled to the system controller 14 across a pair of lines 18 and 20 that are configured to carry power and communications, such as command instructions. Supervision of the notification appliances 24 occurs by polling each notification appliance 24. Addressable notification appliances 24 each have a unique address and both send and receive communications to and from the system controller 14. The addressable notification appliances 24 may communicate their status and functional capability to the system controller 14 over the lines 18 and 20. The communication between the system controller 14 and the addressable notification appliances 24 may be accomplished in various ways, such as described in U.S. Pat. No. 6,313,744 (Capowski et al.), which is incorporated herein by reference in its entirety.

The hardwired notification appliances 26 are coupled with the system controller 14 across a pair of lines 28 and 30. A notification signal sent on the network 22 from the system controller 14 will be received by each hardwired notification appliance 26. An end of line (EOL) device 38 interconnects the ends of the lines 28 and 30 opposite the system controller 14. The EOL device 38 may be a resistor and/or provide voltage monitoring functions.

An embodiment of the present invention comprises a fire alarm visual notification appliance capable of use for emergency lighting situations where building power has been lost. The invention is a multi-use notification appliance in a single assembly that meets fire codes for notification and emergency lighting use.

Notification appliances today are designed to provide a high candela flash rate unsuitable for emergency lighting needs. Emergency lights do not flash or have the high candela brilliance for use as a notification appliance. Emergency lighting also incurs a high cost for maintenance due in part to battery standby requirements. Currently, two separate units are needed in order to meet the separate needs of high candela strobes and emergency lighting.

A fire alarm system already provides emergency power, thus one benefit of the invention is the cost saved by not requiring two sets of standby power. That is, the fire alarm system's standby power system can also be used to provide standby power for the emergency lighting system.

An embodiment of the invention includes an addressable fire alarm visual notification appliance using new (high-brightness) LED technology suitable for emergency evacuation and emergency lighting.

According to an embodiment of the invention, the new appliance has at least two functions: fire alarm visible/audible notification, and emergency lighting. An embodiment of the notification appliance of the present invention employs high-brightness LED in the strobe lamp. Messages sent by a fire control panel can command the unit to flash the LEDs for emergency use or, alternatively, turn them on steady for emergency lighting purposes. In a further embodiment, the appliance is capable of color selection and flash or turn on steady. For example, White Steady On may be used during an Emergency Lighting mode; White Flashing (strobe) may be used during a Fire Alarm; Amber Flashing may be used to indicated an evacuate mode; Amber Steady On may be used during Emergency Notification mode; and Green Steady On may be used to indicate All Clear.

Current notification appliances are not designed to provide emergency lighting. The invention uses LED technology to provide emergency lighting from the same appliance used for fire alarm visible notification, using the same light source.

Multi-use notification by color is an optional feature. In one embodiment, activation may be made from a fire alarm control panel that has been programmed accordingly.

By sequencing multiple appliances, they can provide a visual pathway to an egress. The appliances can be turned on and off in a scrolling (also called strobing, but not to be confused with the high-intensity strobe) fashion for occupants to follow the direction of the flashing appliances to safety. Color selection can identify the situation/condition.

In another embodiment, one or more appliances can be pulsed on and off at a lower intensity (such as used for background emergency lighting) in a duty cycle such as 1 second on, 1 second off, whereby a flashing green appliance may indicate an accessible egress, while a flashing red appliance may indicate an egress that should be avoided. Other duty cycles and color schemes could of course be utilized.

Alternatively, where the intensity of LEDs may not be high enough to meet certain demands, a high-intensity strobe as is known in the art may be combined with an emergency lighting system into a single unit (thus sharing a common backup power system).

While the invention has been described in terms of various specific embodiments, those skilled in the art will recognize that the invention can be practiced with modification within the spirit and scope of the claims.

What is claimed is:

1. A notification appliance, comprising:
at least one high-brightness light-emitting diode (LED); and
a control module configured to receive commands from an external source, and in response to a first command, flash the at least one LED, and in response to a second command, turn the at least one LED on in a steady state.

2. The notification appliance of claim 1, wherein the at least one LED comprises plural LEDs, and wherein a first number of LEDs is used to flash, and a second number of LEDs is used for steady state, at least one LED being used for both.

3. The notification appliance of claim 1, wherein the at least one LED is capable of emitting at least two distinct colors, the control module further configured to select a color to be emitted by the notification appliance

4. The notification appliance of claim 3, wherein the at least one LED comprises plural LEDs, at least one of said plural LEDs being of a first color and at least one of said plural LEDs being of a second color.

5. A notification system, comprising:
a system controller; and
plural notification appliances having at least one high-brightness light-emitting diode (LED) and a control module configured to receive commands from the system controller, and in response to a first command, flash the at least one LED, and in response to a second command, turn the at least one LED on in a steady state, wherein the system controller sequences multiple appliances such that they provide a visual indication of a pathway to an egress.

6. The notification system of claim 5, wherein the system controller selects one of plural colors to be emitted by the sequenced notification appliances to identify a particular situation/condition.
